(19) United States
(12) Patent Application Publication
(10) Pub. No.: US 2007/0201691 A1
(43) Pub. Date: Aug. 30, 2007

(54) METHOD OF STORING OR RECORDING HIGHLY CONFIDENTIAL DATA, PLAYBACK APPARATUS USING HIGHLY CONFIDENTIAL DATA, AND MEMORY STORING HIGHLY CONFIDENTIAL DATA

(76) Inventor: Takeshi KUMAGAYA, Hachioji-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/614,576

(22) Filed: Dec. 21, 2006

(30) Foreign Application Priority Data
Feb. 28, 2006 (JP) 2006-051986

(51) Int. Cl. H04L 9/30

(52) U.S. Cl. 380/30

(57) ABSTRACT

According to one embodiment, a storing or recording method of highly confidential data includes sorting a key set (a set of keys and position information items thereof) according to the position information items (for example, position numbers of a column) for each released apparatus, encrypting each pair of the sorted position information items and the respective keys, and storing the encrypted pairs in a non-volatile memory in order of the sorted position information items.

### CROSS-REFERENCE TO RELATED APPLICATIONS

This application is based upon and claims the benefit of priority from Japanese Patent Application No. 2006-051986, filed Feb. 28, 2006, the entire contents of which are incorporated herein by reference.

### BACKGROUND

1. Field

One embodiment of the invention relates to a method of storing or recording information (encryption key or the like) required to having high confidentiality. The present invention also relates to a playback apparatus (advanced video players or advanced video recorders which play back encrypted High-Definition AV content) using highly confidential data stored or recorded. Further, the present invention relates to a memory storing highly confidential data.

2. Description of the Related Art

Recently, various playback apparatuses (playback-only players, recorders having a playback function, or personal computers equipped with a DVD disk drive and playback software) have been developed. These playback apparatuses can playback AV content data recorded on disk media such as DVDs (Digital Versatile Disc). Stream data which is recorded on DVD discs to be played back by such playback apparatuses are subjected to encryption to prevent unauthorized copy. For data sections of encrypted stream data, mainly adopted is an encryption method based on CSS (Content Scramble System). As a more advanced encryption method, AACS (Advanced Access Content System) has been proposed. If the AACS method is adopted, for example, set manufacturers obtain a specific key set from a key matrix of a licensee, encrypt different combinations of keys and incorporate them into respective playback apparatuses.

Besides the AACS, various encryption methods have been proposed for the purpose of advanced encryption (refer to Jpn. Pat. Appln. KOKAI Pub. No. 2000-347850 and Jpn. Pat. Appln. KOKAI Pub. No. 2000-59355). According to Jpn. Pat. Appln. KOKAI Pub. No. 2000-347850, instruction sequences included in the program to be executed by the semiconductor IC are sorted, the program is encrypted, the instruction sequences are sorted, the encrypted program is recorded, and the recorded program is transmitted to the semiconductor IC. According to Jpn. Pat. Appln. KOKAI Pub. No. 2000-59355, original data is divided into a plurality of files, a dummy file is added to each of the files where necessary, the divided files are sorted if necessary, and encrypted and transmitted by divided file encryption means.

As in the AACS, if key sets for individual playback apparatuses are formed by taking out some keys from an enormous number of encryption keys in matrix owned by licensee, it is highly possible that the keys of each key set are irregularly arranged. When a necessary encryption key is obtained from an encrypted key set including irregularly arranged keys, it is necessary to decode all the keys (at worst) of the encrypted key set, to understand where is the required key. However, it takes a time to perform such processing, and there are cases where malfunction occurs in smooth playback of the encrypted content (for example, flow of content playback is temporarily stopped when the encryption key is changed from one to another key).

An object of the present invention is to provide a method of storing and recording highly confidential data, which specifies a key to be decoded, without decoding all keys of encrypted key set.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A, 1B and 1C are diagrams illustrating method of storing/recording highly confidential data according to a first embodiment of the invention, illustrating how a set (key set) formed of a plurality of pairs of keys and position information items thereof changes in executing the method.

FIGS. 2A, 2B, 2C, 2D, 2E and 2F are diagrams illustrating example how the key set obtained by executing the storing/recording method according to the first embodiment of the invention is used in decoding encrypted content.

FIG. 3 is a flowchart illustrating an example of key set storing/recording processing, which is performed after obtaining and decoding a specific key set (such as encrypted key information provided in the form of a licensee release key disc).

FIG. 4 is a flowchart illustrating an example of processing of decoding encrypted content by using the stored/recorded key set.

FIG. 5 is a block diagram illustrating an example of a playback apparatus equipped with a memory storing highly confidential data.

### DETAILED DESCRIPTION

Various embodiments according to the invention will be described hereinafter with reference to the accompanying drawings. In general, according to one embodiment of the invention, a method of storing or recording highly confidential data comprises sorting a plurality of keys of a set including pairs of the keys and respective position information items, according to the position information items encrypting each of the sorted pairs and storing or recording the encrypted pairs in order of the sorted position information items.

With reference to drawings, explained is a method of storing/recording highly confidential data and a playback apparatus using highly confidential data, according to various embodiments of the present invention. Specifically, explained is a method of storing highly confidential data in which, when highly confidential data comprising keys and position information items corresponding to the keys is encrypted and stored in a non-volatile memory, the data is sorted based on the position information items, then encrypted and stored in the non-volatile memory.

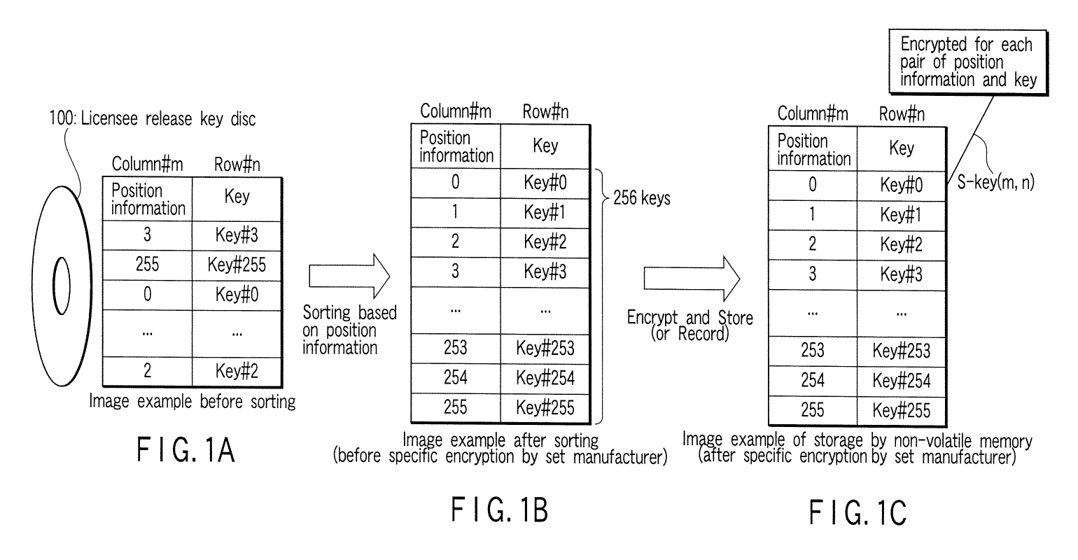

FIGS. 1A, 1B and 1C are diagrams illustrating method of storing/recording highly confidential data according to a first embodiment of the invention, illustrating change of contents of a set (key set) formed of a plurality of pairs each comprising a key and a position information item of the key. In a licensee release key disc (for example, a disc which the set manufacturer of the playback apparatus purchases from the licensee) 100 shown in FIGS. 1A, 1B and 1C, a set (key set) of pairs, each of which comprising a position information item and a key associated with the position, is encrypted and stored by a specific method of the licensee (the encrypting method itself may be a conventional one). The set manufacturer which has properly purchased it can decode the encrypted key set (they can obtain a necessary decoding key or a decoding method from the licensee).

In the key set decoded by the set manufacturer, the pairs of position information items and keys associated with the positions are not always stored in a regular order (for example, in a descending order or an ascending order of the position information items), but may be stored at random. FIG. 1A illustrates an example of the key set stored at random. If the key set is encrypted as it is by the specific method of the set manufacturer (to install the set key in each apparatus released by the set manufacturer), the position information is also encrypted together, and it is impossible to understand where each of the keys is stored. In this case, to know where a key to be used is located, the encrypted key set is decoded to plain information.

In the example of FIG. 1A, if the key to be used is key #3, the processing of obtaining the necessary key can be performed for a short time since the key #3 is found by decoding the pair of the key set once. However, if the key to be used is key #2, the necessary key cannot be found until all the pairs of the key set are decoded, and processing of obtaining the necessary key requires much time.

Therefore, after information of the key set obtained from the licensee is decoded, the pairs of the position information items and the keys are sorted in a regular order. Although there are some possible sorting methods, the simplest and fastest one is a method of sorting position information items in an ascending order or a descending order (it is possible to perform sorting even-numbered position information items in an ascending order and sorting odd-numbered position information items in a descending order). FIG. 1B is an example of a key set sorted in an ascending order of the position information items. The sorted key set is encrypted by a specific method of the set manufacturer for each pair in the order after sorting. FIG. 1C is an example of the encrypted key set. The encrypting method itself may be a conventional method. The encrypting method used by the set manufacturer is generally different from the encrypting method used for the licensee release key disc 100. (Although they may be the same, if the same, different decoding keys should be used.)

Although it is unclear from the outside which key is located in where in the encrypted key set of FIG. 1C, the apparatus designer of the set manufacturer knows the rule of sorting (for example, that the position information items are sorted in an ascending order). Therefore, for example, if the key to be used is key #2, the designer knows, without decoding the whole key set, that the third pair (the position information item is 2) (for example, S-Key (m, n)=S-Key (2, 1900)) from the top of the sequence of the encrypted key set should be decoded.

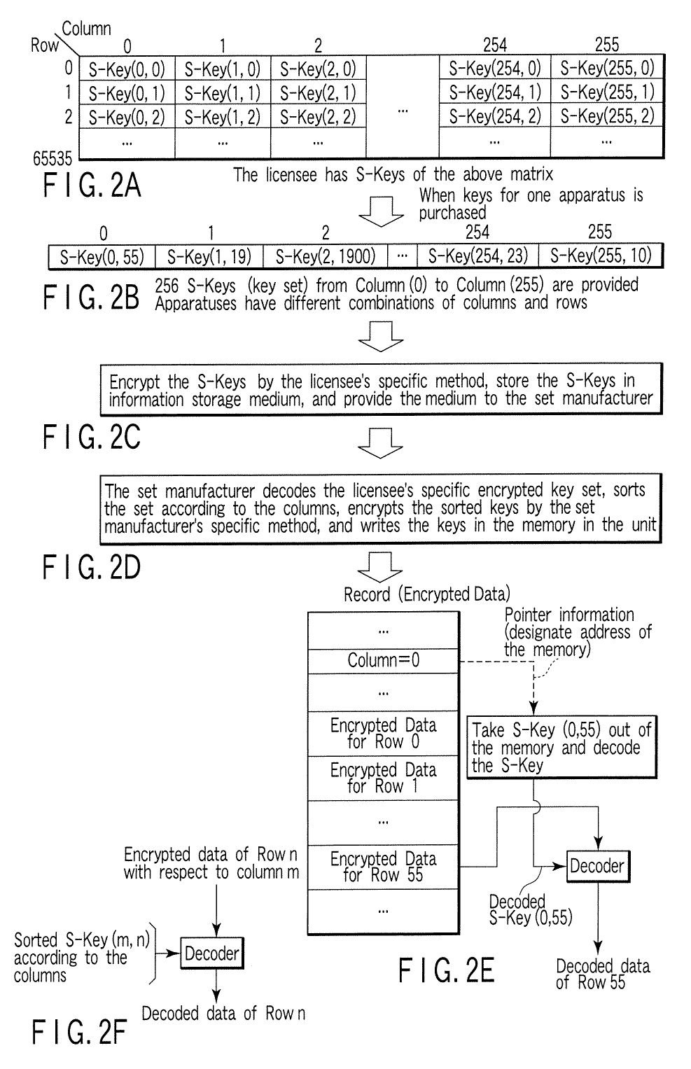

FIGS. 2A, 2B, 2C, 2D, 2E and 2F are diagrams illustrating example as to how the key set obtained by performing the storing/recording method of the embodiment of the present invention is used when encrypted content is decoded. In this example, the licensee has a key information (S-Key) matrix of 256 columns (Column) and 65535 rows (Row) (refer to FIG. 2A). When the set manufacturer purchases a key for one apparatus, the set manufacturer is provided with key information for one row from the licensee (refer to FIG. 2B). In this example, provided are 256 S-Keys (key set) extracted from Columns #0 to #255 and Rows #10 to #1900. The S-keys (key set) have combinations of columns and rows which are different between apparatuses (combinations of 24 bits=2²⁴ are possible, if the columns are 8 bits and the rows are 16 bits).

The licensee prepares sets of 256 S-keys (key set) extracted from the matrix of FIG. 2A for numbers of apparatuses required by the set manufacturers. The licensee encrypts the sets of S-keys by the licensee's specific method, stores them in an information storage medium (licensee release key disc 100 or the like), and provides the medium to the set manufacturer (refer to FIG. 2C).

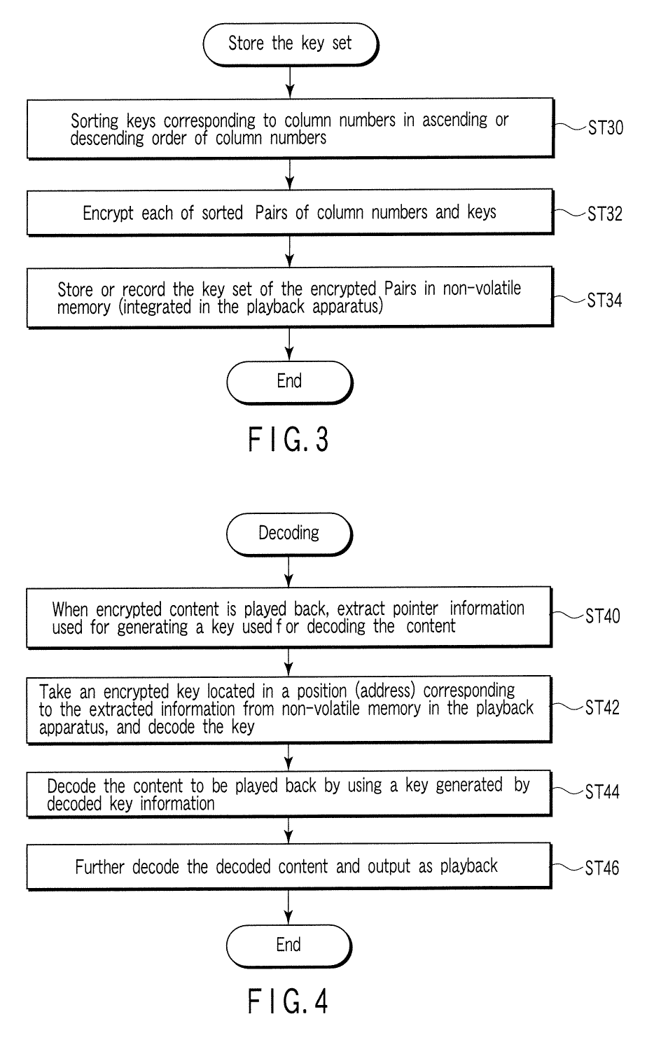

FIG. 3 is a flowchart illustrating an example of key set storing/recording processing, which is performed after a specific key set (for example, encrypted key information provided in the form of a licensee release key disc) is obtained from the outside and decoded.

The set manufacturer decodes the key set read from the provided medium (refer to FIG. 1A), and sorts the decoded key set according to the columns (the numbers of the position information items) (ST 30 of FIG. 3) (refer to FIG. 1B). Then, the set manufacturer subjects each sorted pair of the column number and the associated key to encryption specific to the set manufacturer (ST 32) (refer to FIG. 1C), and writes the encrypted pair in a non-volatile memory (an electrically-programmable ROM or the like) in a unit (playback apparatus) to be used (ST34) (refer to FIG. 2D).

FIG. 4 is a flowchart explaining an example of processing of decoding encrypted content by using the stored/recorded key set. The key set (refer to FIG. 1C) subjected to encryption specific to the set manufacturer is stored in the non-volatile memory. The playback apparatus including the memory is configured to play back the encrypted (copyrighted) content while decoding the content by using the key set stored in the memory.

For example, stream (AV content or a video title) recorded on, for example, a next-generation high-definition video disc is encrypted, and a specific decoding key is required for decoding the stream. The decoding key is obtained as follows. Specifically, an S-key and encrypted data (Encrypted Data for Row #n) in the Record (FIG. 2E) are decoded and, through necessary processing, key information for decoding the stream (AV content or the like) is generated.

Specifically, for example, when the encrypted stream (AV content or the like) recorded on the high-definition video disc is played back, pointer information (column value) used for generating a key used for decoding the stream is extracted from the Record (FIG. 2E) recorded on the high-definition video disc (ST40). (The pointer information itself is not encrypted, and immediately extracted from the Record. The Record can be described in a part (such as a header) of the stream to be played back, although not shown.)

In the example of an encrypted key (FIG. 2B) located in a position (or an address) corresponding to the extracted pointer information, an S-Key (0, 55) is first extracted from the non-volatile memory in the playback apparatus and decoded (ST42). For example, supposing that the column value in the Record to be used at present is “0” and a key corresponding to the value is S-Key (0, 55), Row 55 is encrypted data to be decoded by the S-Key (0, 55). The encrypted data of Row 55 is decoded by the S-Key (0, 55). Data obtained by such decoding serves as key information used for generating a key used for decoding the stream (AV content). A key (content key/title key) is generated by using the key information through some processing steps (for example, referring to an encryption information table (not shown)), and the stream including the content (title) to be played back is decoded by using the key (ST44). The decoded content is further subjected to necessary decoding (image decoding, sound decoding, sub-image decoding), and outputted as playback output (ST46).

When each of m and n is an integer, the above process is generalized as follows by using m and n. Specifically, S-Key (m, n) sorted according to the column is used for decoding encrypted data of Row n of Column m (refer to FIG. 2F). Further, a key (content key/title key) necessary for decoding a specific stream (content/title) is generated by using the data of Row n decoded by the S-Key (m, n) (for example, by referring to an encryption information table (not shown)).

In the embodiment of the invention, it is unnecessary to change flow of processing to obtain a key (content key/title key) necessary for decoding the specific stream (content/title) to be decoded for each playback apparatus. However, since the contents of non-volatile memories (of a key set) provided to playback apparatuses are different from each other, the playback apparatuses have different information contents of a key used for decoding a specific stream. Therefore, when an encoded AV content/title is played back, it is possible to inquire into the details of the playback apparatus that has played back the content/title (for example, if it is found out that “an S-key stored in a non-volatile memory of serial No. ______” has been used as the content key/title key used for playback, it is possible to trace the model name and serial number of the playback apparatus, the factory which manufactured the playback apparatus, the shipping period, and the distribution route of the apparatus, on the basis of manufacturing management data stored by the manufacturer).

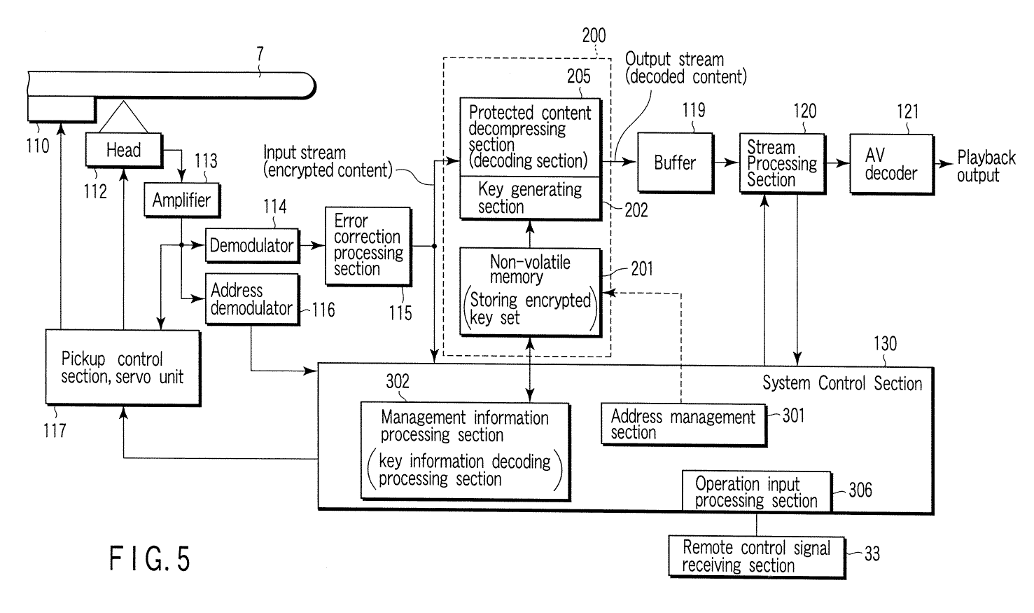

FIG. 5 is a block diagram illustrating an example of a playback apparatus equipped with a memory storing highly confidential data. An optical disc (such as an HD_DVD disc storing copyrighted content) 7 is rotated and driven by a disc motor 110. Information recorded on the optical disc 7 is read by an optical head 112, converted into an electrical signal and input to an amplifier 113. Output of the amplifier 113 is input to a pickup control section and servo unit 117, and input to a demodulator 114 and an address demodulating section 116.

The pickup control section and servo unit 117 generates a focus error signal and a tracking error signal and the like by using the output of the amplifier 113, and controls an actuator of the optical head 112 to control focus and tracking. Further, the pickup control section and servo unit 117 performs control to stabilize rotation of the disc motor 110.

The demodulator 114 demodulates a playback signal binarized by a binary circuit (not shown). This demodulating converts a signal from 16 bytes to 8 bytes, using a conversion table. The demodulated signal is input to an error connection processing section 115 to correct an error. The address demodulating section 116 reads a physical address from the playback signal. The read address is taken in a system control section 130, and managed by an address management section 301.

The system control section 130 can also control the movement position of the optical head 112 through the pickup control section and servo unit 117. Further, the system control section 130 also sets a rotation number of the disc motor 110. In the demodulated signal which has been error-corrected by the error correction processing section 115, management information such as information of a file system is input to a management information processing section 302 of the system control section 130.

In the demodulated signal from the error correction processing section 115, a content portion (including encrypted data) is supplied to a protected content decompressing section (decoding section) 205. The protected content decompressing section 205 is provided with a key generating section (including a register which stores key data, and a memory which stores an encryption information table) 202. The protected content decompressing section 205 decodes the encrypted content in the input stream by using a key set in the key generating section 202. If the input content is not encrypted, the content passes through the protected content decompressing section 205 under control of the system control section 130.

Specifically, the key generating section 202 generates corresponding key information (for example, the decoded Row 55 data in FIG. 2E) on the basis of a predetermined key (for example, S-key (0, 55)) taken out of the key set (refer to FIG. 1C or FIG. 2B) in the non-volatile memory 201. The key generating section 202 also generates a key (content key/title key) for decoding the stream (AV content/title) read from the disc 7, with reference to an encryption information table (not shown) on the basis of the generated key information (decoded Row 55 data). The protected content decompressing section 205 decodes encrypted content (AV content/title) in the input stream by using the generated key (content key/title key).

The content output from the protected content decompressing section 205 is input to a stream processing section 120 through a buffer 119. The stream processing section 120 separates the content into a video packet, an audio packet, a sub-image packet, and a control packet including navigation data and the like. The control packet including navigation data is taken in the system control section 130, and managed by the management information processing section 302.

Further, the video packet, the audio packet, and the sub-image packet are input to an AV decoder 121, and subjected to decoding. The sub-image packet includes data such as subtitles, and superposed on the video signal after decoding. Thereby, playback output (of the decoded content) is obtained from the decoder 121.

Next, the system control section 130 is explained. The system control section 130 is connected with a remote control signal receiving section 33 which controls operation of the apparatus. Signals received by the remote control signal receiving section 33 are recognized by the operation input processing section 306. The address management section 301 recognizes physical addresses, and manages logical addresses included in the navigation data. The management information processing section 302 manages management information such as file system, and also manages management information transmitted as navigation data, such as attribute information.

The playback apparatus of FIG. 5 includes the non-volatile memory (EPROM, EEPROM, or battery-backed SRAM) 201 storing a key set (FIG. 1C) unique to the apparatus, which is encrypted by the set manufacturer's specific method. In the apparatus, necessary key information (S-Key) is taken out of the non-volatile memory 201 by control (for example, the firmware of FIG. 4) of the processing section 302 and decoded, and new key information (for example, the content key/title key obtained with reference to an encryption information table or the like on the basis of the decoded Row data of FIG. 2E) generated by using the key information is set in the key generating section 202. Then, the protected content decompressing section (decoding section) 205 decodes an input stream including encrypted content, by using the set content key/title key. In the structure of FIG. 5, the elements 201, 202, and 205 may be formed as a decoding processing section 200 being an integrated circuit.

### Conclusion of Embodiments

According to the embodiment of the present invention:

1) A key set (a set of keys and position information items thereof) is sorted according to the position information (for example, position numbers of the column) for each released apparatus; and

2) the sorted position information items and keys are paired, each of the pairs are encrypted, and the encrypted pairs are stored in the non-volatile memory 201 in the numerical order of the sorted position information items.

For example, there is a position information item for decoding on the HD DVD video disc 7. Supposing that a key indicated by the position information item is stored in the non-volatile memory 201, inconvenience is caused if keys stored in the non-volatile memory 201 are not sorted according to a known rule. Specifically, it is necessary to decode each data in the non-volatile memory 201 one by one to check the position information item. If the decoded data does not agree with the required item, next data has to be further decoded to check the position information item thereof. Although the first decoded data may fortunately agree with the required item, the user may have to decode all the data stored in the non-volatile memory 201 in the worst case to obtain a key corresponding to the position information on the disc. However, according to the invention, the data items are sorted according to a certain rule such as ascending order or descending order, and the encrypted key information items (S-Key (m, n)) are stored in the certain order. This structure enables easy taking of a key (Key #n) corresponding to the position information item (Column #m) on the disc.

### Effects Obtained by the Embodiment

In the prior art, position information is obtained by decoding highly confidential data and checking the decoded data. However, according to the invention, key data items sorted according to the position information items are encrypted and stored in the non-volatile memory. This structure enables the user to obtain a required key data item without troubling to decode the data and check the position information.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of storing or recording highly confidential data, comprising:
sorting a plurality of keys of a set including pairs of the keys and respective position information items, according to the position information items;
encrypting each of the sorted pairs; and
storing or recording the encrypted pairs in order of the sorted position information items.

2. A method according to claim 1, wherein the set is formed of a plurality of key information items arranged in a matrix being formed of a plurality of columns and a plurality of rows, the position information items correspond to numbers assigned to the respective columns of the matrix, and the sorting according to the position information items includes sorting in an ascending order or a descending order of the numbers assigned to the respective columns.

3. A method according to claim 1, wherein the set before the sorting is encrypted, and the sorting is performed after decoding the encrypted set.

4. A method according to claim 2, wherein the set before the sorting is encrypted, and the sorting is performed after decoding the encrypted set.

5. A method according to claim 3, wherein the encrypting after the sorting is different from the encryption of the set before the sorting.

6. A method according to claim 4, wherein the encrypting after the sorting is different from the encryption of the set before the sorting.

7. A playback apparatus comprising:
a storing section which sorts a plurality of keys of a set including pairs of the keys and respective position information items, according to the position information items, encrypts each of the sorted pairs, and stores or records the encrypted pairs in order of the sorted position information items;
a reading section which reads information including content from an information storage medium, and provides an input stream, the content being encrypted separately from the encryption of the keys; and
a decoding section which decodes the encrypted content included in the input stream by using a key generated by using a predetermined key information item taken out of a key set in the storing section, and provides an output stream.

8. A playback apparatus according to claim 7, wherein the set is formed of a plurality of key information items arranged in a matrix being formed of a plurality of columns and a plurality of rows, the position information items correspond to numbers assigned to the respective columns of the matrix, and the sorting according to the position information items includes sorting in an ascending order or a descending order of the numbers assigned to the respective columns.

9. A playback apparatus according to claim 8, wherein the key set corresponding to the key information items having different combinations of the columns and the rows for each playback apparatus is stored or recorded on the storing section.

10. A non-volatile memory which sorts a plurality of keys of a set including pairs of the keys and respective position information items, according to the position information items, encrypts each of the sorted pairs, and stores or records the encrypted pairs in order of the sorted position information items.

11. A non-volatile memory according to claim 10, wherein the set is formed of a plurality of key information items arranged in a matrix being formed of a plurality of columns and a plurality of rows, the position information items correspond to numbers assigned to the respective columns of the matrix, and the sorting according to the position information items includes sorting in an ascending order or a descending order of the numbers assigned to the respective columns.

12. A non-volatile memory according to claim 11, wherein the memory stores or records the key set corresponding to the key information items having different combinations of the columns and the rows for each non-volatile memory.
